(19) United States
(12) Patent Application Publication
(10) Pub. No.: US 2026/0086597 A1
(43) Pub. Date: Mar. 26, 2026

(54) SYSTEMS AND METHODS FOR REDUCING POWER LEAKAGE IN A SYSTEM-ON-A-CHIP (SOC)

(71) Applicant: QUALCOMM INCORPORATED, San Diego, CA (US)

(72) Inventors: Dinesh Kumar CHOUDHARY, Tonk (IN); Sai Sneha Venkata YESANTARAO, Hyderabad (IN); Raja Simha REVANURU, Hyderabad (IN); Chandan AGARWALLA, San Diego, CA (US)

(21) Appl. No.: 18/893,743

(22) Filed: Sep. 23, 2024

(51) Int. Cl. G06F 1/08; G06F 1/3296

(52) U.S. Cl. CPC G06F 1/08; G06F 1/3296

(57) ABSTRACT

Systems and methods are provided for reducing power consumption in an SoC by reducing the clock frequency of a cluster of processing cores or by reducing both the clock frequency and the supply voltage of the cluster when the cluster is in clock gating mode. With existing clock gating processes used in SoCs, if a cluster is in clock gating mode, the clock is still running at the same speed as when ungated, which results in significant power leakage. If the clock is running at a higher speed when the cluster is in clock gating mode, more power leakage will occur than if the clock is running at a lower speed when the cluster is in clock gating mode. By reducing the clock frequency of the cluster when it is in clock gating mode, a substantial reduction in power leakage can be realized.

### DESCRIPTION OF THE RELATED ART

A computing device may include multiple processor-based subsystems. Such a computing device may be, for example, a portable computing device (“PCD”), such as a laptop or palmtop computer, a cellular telephone or smartphone, a portable digital assistant, a portable game console, etc. Still other types of PCDs may be included in automotive and Internet-of-Things (“IoT”) applications. A computing device may also be a stationary computer, such as a personal computer (PC) or various types of desktop computers or workstation computers.

Such processor-based subsystems may be included within the same integrated circuit chip or in different chips. A “system-on-a-chip”, or “SoC”, is an example of one such chip that integrates numerous subsystems to provide system-level functionality. For example, an SOC may include one or more types of processors, such as central processing units (“CPU” ), graphics processing units (“GPU” ), digital signal processors (“DSP” ), and neural processing units (“NPU” ). An SOC may include other subsystems as well, such as a transceiver or “modem” subsystem that provides wireless connectivity, a memory subsystem, etc.

SoC power management solutions use a variety of power-saving processes to save power, including clock gating and power gating. Clock gating involves configuring logic gates of inactive circuits to ignore the clock signal being delivered to the logic gates, thereby preventing unnecessary switching of the logic gates. Power gating involves selectively cutting off power to inactive circuits. Power management solutions trigger clock gating and/or power gating by placing processors or processor clusters in various power-saving states, or modes, based on certain conditions.

Idle state for a processor or a processor cluster triggers various power-saving processes ranging from different levels of clock gating to different levels of power gating. The different levels of clock gating and power gating have different idle state entry and exit timelines and different levels of energy consumption. For example, processor core clock gating is typically a light-weight idle state executed within the kernel that has relatively short idle state entry and exit timelines. On the other hand, supply rail collapse mode power gating (i.e., shutting off power from the supply rails to inactive circuits) has a relatively long idle state entry and exit timeline because it involves software calls to secure firmware to cause it to program hardware to perform the supply rail collapse. In general clock gating has shorter idle state entry and exit timelines than power gating, but power gating reduces power consumption to a greater extent than clock gating.

Cluster clock-gating is typically triggered in hardware based on whether the cores packaged within the cluster are all in idle state and whether a coordinated power state is selected from the kernel. With existing clock gating processes used in SoCs, if a cluster is in clock gating mode, the clock is still running at the same speed as when ungated, which results in significant power leakage.

### SUMMARY OF THE DISCLOSURE

Systems, methods, and other examples are disclosed for reducing power consumption in an SoC by reducing the clock frequency of a cluster or the clock frequency and the supply voltage of the cluster when the cluster is in clock gating mode.

An exemplary embodiment of the method comprises, determining when at least a first cluster of processing cores has entered a cluster clock gating state, and, in response to determining that the first cluster has entered the cluster clock gating state, reducing a clock frequency used by the processing cores of the first cluster from a first clock frequency to a second clock frequency that is less than the first clock frequency.

An exemplary embodiment of the system comprises processing logic configured to determine when at least a first cluster of processing cores has entered a cluster clock gating state, and, in response to determining that the first cluster has entered the cluster clock gating state, reduce a clock frequency used by the processing cores of the first cluster from a first clock frequency to a second clock frequency that is less than the first clock frequency.

An exemplary embodiment of a computer program for execution by a processor for reducing power consumption in an SoC comprises a first set of computer instructions for determining when at least a first cluster of processing cores has entered a cluster clock gating state and a second set of computer instructions for, in response to determining that the first cluster has entered the cluster clock gating state, reducing a clock frequency used by the processing cores of the first cluster from a first clock frequency to a second clock frequency that is less than the first clock frequency.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1 illustrates a block diagram of a system in accordance with an exemplary embodiment of the present disclosure reducing power consumption in an SoC.

FIG. 2 illustrates a graph showing the percentage duration of a cluster and of four cores of the cluster spent in low power, i.e., idle, mode (LPM) for five different use case scenarios in which an existing power saving solution is implemented in the SoC.

FIG. 3 is a block diagram of the current power management system currently used in some SoCs for managing power states for processing cores and for clusters of processing cores of the SoC.

FIG. 4 is a block diagram of the power management system of an SoC in accordance with a representative embodiment of the present disclosure.

FIG. 5 is a flow diagram that represents the method of the present disclosure in accordance with a representative embodiment for reducing power leakage in an SoC.

FIG. 6 is a flow diagram that represents the method of the present disclosure in accordance with another representative embodiment for reducing power leakage in an SoC.

FIG. 7 illustrates an example of a PCD, such as a mobile phone or a smartphone, for example, in which exemplary embodiments of systems, methods, computer-readable media, and other examples of the inventive principles and concepts of the present disclosure may be implemented.

### DETAILED DESCRIPTION

As indicated above, with existing clock gating processes used in SoCs, if a cluster is in clock gating mode, the clock is still running at the same speed as when ungated, which results in significant power leakage. In many cases, there is a very large increase (e.g., exponential) in power leakage as the clock speed increases from the minimum clock speed to the maximum clock speed. Therefore, if the clock is running at a higher speed when the cluster is in clock gating mode, more power leakage will occur than if the clock is running at a lower speed when the cluster is in clock gating mode. Representative embodiments of the present disclosure are directed to systems and methods for reducing power consumption in an SoC by reducing the clock frequency of a cluster or the clock frequency and the supply voltage of the cluster when the cluster is in clock gating mode. Representative embodiments of the systems and methods are described below in detail with reference to the figures.

In the following detailed description, for purposes of explanation and not limitation, exemplary, or representative, embodiments disclosing specific details are set forth to provide a thorough understanding of an embodiment according to the present teachings. The word “exemplary” is used herein to mean “serving as an example, instance, or illustration. ” The words “illustrative” or “representative” may be used herein synonymously with “exemplary. ” Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims. Moreover, descriptions of well-known apparatuses and methods may be omitted to not obscure the description of the example embodiments. Such methods and apparatuses are clearly within the scope of the present teachings.

The terminology used herein is for purposes of describing exemplary or representative embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory device”, as that term is used herein, is intended to denote a non-transitory computer-readable storage medium that can store computer instructions, or computer code, for execution by one or more processors. References herein to a “memory device” should be interpreted as including one or more memory devices.

A “processor”, as that term is used herein encompasses an electronic component that can execute a computer program or executable computer instructions. References herein to a computer comprising “a processor” should be interpreted as one or more processors. The processor may for instance be a multi-core processor comprising multiple processing cores, each of which may comprise multiple processing stages of a processing pipeline. A processor may also refer to a collection of processors within a single system or distributed amongst multiple systems.

The term “logic”, as that term is used herein, denotes digital circuits, such as digital gate structures, that are combined and configured in a particular manner to achieve one or more functions. For example, control logic can be a combination of digital circuits that have been combined and configured in a particular manner to achieve one or more control functions, either solely in hardware or in a combination of hardware, software and/or firmware.

A computing device may include multiple subsystems, cores or other components. Such a computing device may be, for example, a personal computing device (PCD), such as a laptop or palmtop computer, a cellular telephone or smartphone, a portable digital assistant, a portable game console, an automotive safety system, etc., or a non-portable computing device (NPCD) such as, for example, a PC, a desktop or a workstation computer.

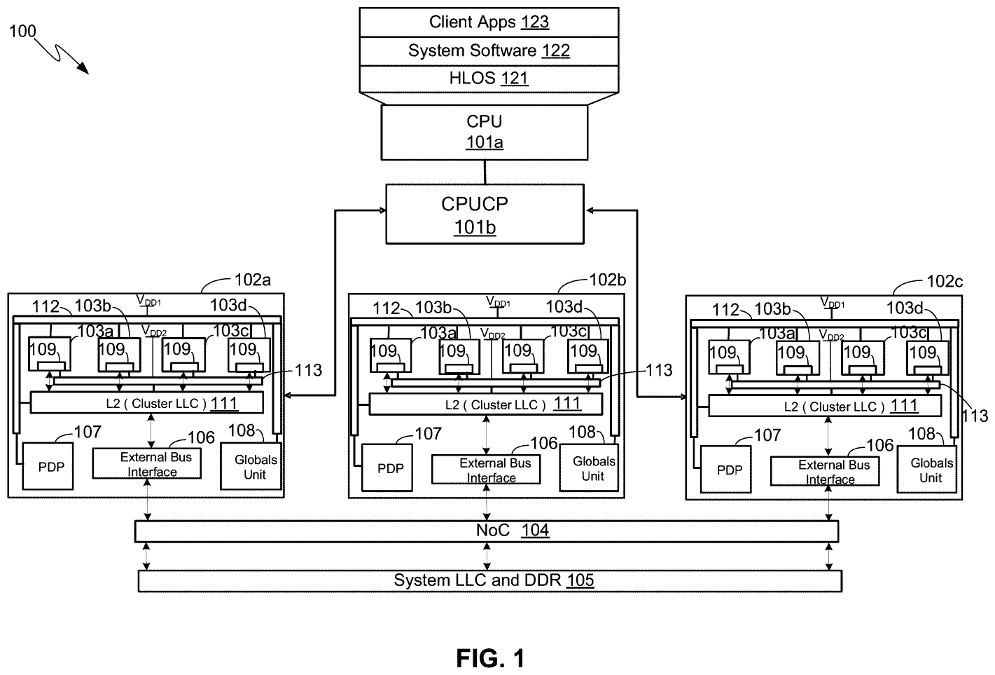

FIG. 1 illustrates a block diagram of a system 100 in accordance with an exemplary embodiment for reducing power consumption in an SoC. In accordance with this exemplary embodiment, the system 100 comprises a CPU 101a, a CPU Control Processor (CPCU) 101b, multiple processor clusters 102a-102c, each of which comprises multiple processing cores 103a-103d, a network on a chip (NoC) 104 and system memory 105 comprising system lower level cache (LLC) memory and double data rate dynamic random access (DDR) memory. The system 100 can comprises any number, N, of clusters 102a-102d, each of which can comprise any number, P, of processing cores 103a-103d, where N and P are positive integers that are greater than or equal to one. In this exemplary embodiment, N=3 and P=4. Each processing core 103a-103d includes level one (L1) cache memory 109 that holds data and instructions that are transferred between the processing core 103a-103d and a level 2 (L2) cache memory 111 of the respective cluster 102a-102c.

Each of the clusters 102a-102c includes an external bus interface 106 that interfaces with the NoC 104 to provide communications between the clusters 102a-102c and other subsystems of the system 100, including system memory 105. Each cluster 102a-102c also includes a power and debug management processor (PDP) 107 and a globals unit 108. The PDP 107 is typically a microcontroller configured to execute firmware for controlling circuitry and logic of the globals unit 108. Each globals unit 108 comprises all of the IP blocks that are specific to the respective cluster 102a-102c, such as the core and cluster power state machines, a phase-locked loop (PLL) circuit that is used by all of the processing cores 103a-103d of the respective cluster 102a-102c, and one or more timers. The PDP 107 interacts with the globals unit 108 to control operations of the IP blocks of the globals unit 108.

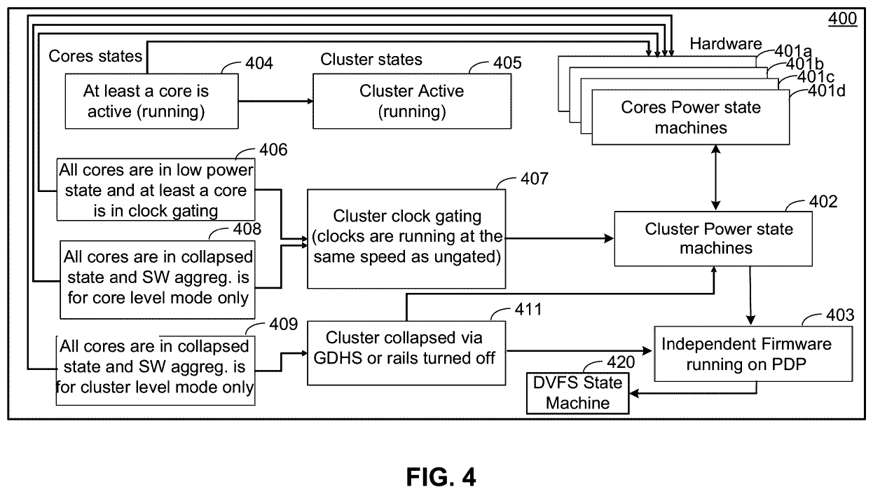

In accordance with this exemplary embodiment, each cluster 102a-102c has first and second supply voltage rails 112 and 113, respectively. The first supply voltage rail 112 supplies a first supply voltage, V_{DD1}, to the processing cores 103a-103d, to the logic of the L2 cache memory 111, to the PDP 107 and to the globals unit 108. The second supply voltage rail 113 supplies a second supply voltage, V_{DD2}, to the L1 cache memory 109 and to the memory cells of the L2 cache memory 111. Each cluster 102a-102c typically comprises its own voltage and frequency supplies for performing dynamic voltage and frequency scaling. As will be described below in more detail, the supply voltages for the rails 112 and 113 can be dynamically scaled along with dynamic scaling of the clock frequencies of the processing cores 103a-103d based on certain conditions being detected. The clock frequencies are generated by clock circuits within the globals units 108. In accordance with the preferred embodiment, the global units 108 include dynamic voltage and frequency scaling (DVFS) circuitry for scaling the clock frequencies or for scaling both the clock frequencies and the supply voltages when the respective cluster 102a-102c is in clock gating mode, as will be described below with reference to FIG. 4.

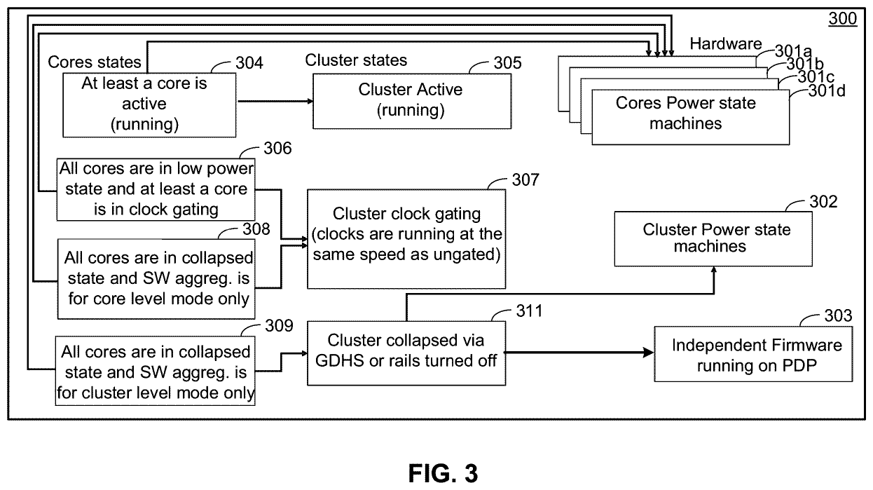

The CPU 101a runs a high-level operating system (HLOS) 121, system software 122 and various client apps 123. To perform power management in the system 100, the HLOS 121 controls the execution of the system software 122 to cause it to interact with the CPUCP 101b, which interacts with the PDP 107 to cause it to perform certain power management operations that are described below in more detail with reference to FIGS. 3 and 4. Some aspects of power management of the cores 103a-103d and of the clusters 102a-102c are managed through the system software 122 executed by the CPU 101a and controlled by the kernel of the HLOS 121, whereas other aspects of power management of the cores 103a-103d and of the clusters 102a-102d are managed by the core and cluster PSMs (logic inside of the globals units 108) in combination with the PDP 107 independently of the CPU 101a and HLOS 121. The main role of the CPUCP 101b is to coordinate cluster power gating collapses and other subsystem-level operations. In general, for power management, the HLOS 121 is the decision maker, and based on decisions made by the HLOS 121, firmware running at the subsystem level on the CPUCP 101b interacts with firmware running on the PDP 107 to cause it to execute the power modes in coordination with the core and cluster PSMs of the globals units 108.

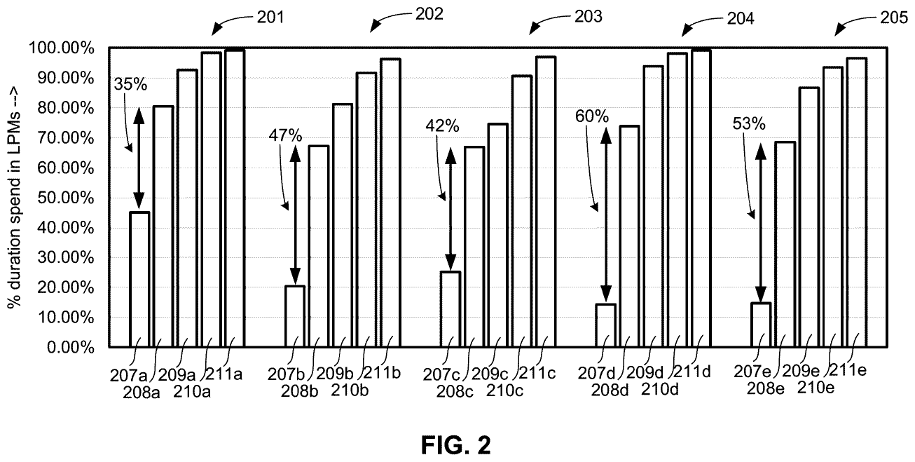

FIG. 2 illustrates a graph showing the percentage duration of one of the clusters 102a shown in FIG. 1 and of four cores 103a-103d of the cluster 102a spent in low power, i.e., idle, mode (LPM) for five different use case scenarios in which an existing power saving solution is implemented in the SoC. The use case scenarios used to generate the graph are five different application programs of the type that are commonly executed by a laptop computer or a smart phone, namely, an assessment of battery life (ABL) idle application program, an ABL browser application program, an ABL productivity application program, a local video playback application program and a streaming video application program.

Bars 207a-211a correspond to the percentage duration of, respectively, the cluster 102a, core 103a, core 103b, core 103c, and core 103d spent in LPM for the first use case scenario in which the ABL idle program is being executed by the cluster. Bars 207b-211b correspond to the percentage duration of, respectively, the cluster 102a, core 103a, core 103b, core 103c, and core 103d spent in LPM for the second use case scenario in which the ABL browser program is being executed by the cluster 102a. Bars 207c-211c correspond to the percentage duration of, respectively, the cluster 102a, core 103a, core 103b, core 103c, and core 103d spent in LPM for the third use case scenario in which the ABL productivity program is being executed by the cluster 102a. Bars 207d-211d correspond to the percentage duration of, respectively, the cluster 102a, core 103a, core 103b, core 103c, and core 103d spent in LPM for the fourth use case scenario in which the local video playback program is being executed by the cluster. Bars 207e-211e correspond to the percentage duration of, respectively, the cluster 102a, core 103a, core 103b, core 103c, and core 103d spent in LPM for the fifth use case scenario in which the streaming video program is being executed by the cluster 102a.

For all five use case scenarios, one of the following three conditions exists: (1) all of the cores of the cluster are in the clock gating state; (2) at least one of the cores is in the clock gating state and the others are in the collapsed state; or (3) all of the cores are in the collapsed state, but coordinated idle state has not been selected. The collapsed state is a power gating state in which either (1) the supply voltage rail sourcing the core has been turned off or (2) a globally distributed head switch (GDHS) circuit has been used to disconnect the core from the supply voltage for the case where the supply voltage rail is supplying one or more other cores that are in active mode.

For the first use case scenario, for approximately 80% of the time, all of the cores 103a-103d are idle and are either in clock gating mode or power gating mode, as indicated by bars 207a-211a. The cluster 102a is in power gating mode approximately 45% of the time, as indicated by bar 207a. Approximately 35% of the time, the cluster 102a is in clock gating mode. Cluster clock gating is autonomously triggered. With the existing power management solution, for the 35% of the time that the cluster 102a is in clock gating mode, the clock signal used by the cluster 102a is at the same frequency as when the cluster 102a is in the ungated mode, which results in a significant loss of power due to leakage current.

For the second use case scenario, for approximately 67% of the time, all of the cores 103a-103d of the cluster 102a are idle and are either in clock gating mode or power gating mode, as indicated by bars 208b - 211b. The cluster 102a is in power gating mode approximately 20% of the time, as indicated by bar 207b. Approximately 47% of the time, the cluster 102a is in clock gating mode. With the existing power management solution, for this 47% of the time that the cluster 102a is in clock gating mode, the clock signal used by the cluster 102a is at the same frequency as when the cluster 102a is in the ungated mode, which results in a significant loss of power due to leakage current.

For the third use case scenario, for approximately 67% of the time, all of the cores 103a-103d are idle and are either in clock gating mode or power gating mode, as indicated by bars 208c-211c. The cluster 102a is in power gating mode approximately 25% of the time, as indicated by bar 207c. Approximately 42% of the time, the cluster 102a is in clock gating mode. With the existing power management solution, for the 42% of the time that the cluster 102a is in clock gating mode, the clock signal used by the cluster 102a is at the same frequency as when the cluster 102a is in the ungated mode, which results in a significant loss of power due to leakage current.

For the fourth use case scenario, for approximately 73% of the time, all of the cores 103a-103d are idle and are either in clock gating mode or power gating mode, as indicated by bars 208d-211d. The cluster 102a is in power gating mode approximately 13% of the time, as indicated by bar 207d. Approximately 60% of the time, the cluster 102a is in clock gating mode. With the existing power management solution, for the 60% of the time that the cluster 102a is in clock gating mode, the clock signal used by the cluster 102a is at the same frequency as when the cluster 102a is in the ungated mode, which results in a significant loss of power due to leakage current.

For the fifth use case scenario, for approximately 67% of the time, all the cores 103a-103d are idle and are either in clock gating mode or power gating mode, as indicated by bars 208e-211e. The cluster 102a is in power gating mode approximately 14% of the time, as indicated by bar 207e. Approximately 53% of the time, the cluster 102a is in clock gating mode. With the existing power management solution, for the 53% of the time that the cluster 102a is in clock gating mode, the clock signal used by the cluster 102a is at the same frequency as when the cluster 102a is in the ungated mode, which results in a significant loss of power due to leakage current.

It can be seen from the graph shown in FIG. 2 and the discussion above that with the current power management solution, the cluster 102a spends a large amount of time in clock gating mode during which the speed of the clock remains the same as when ungated. In addition, as indicated above, as the clock speed increases from the minimum clock speed to the maximum clock speed, the power leakage that occurs in clock gating mode increases exponentially.

FIG. 3 is a block diagram of an existing power management system 300 used in some SoCs having the architecture shown in FIG. 1 for managing power states for processing cores and for clusters of processing cores of the SoC. The block diagram shown in FIG. 3 depicts different core states and different cluster states for a single cluster having four processing cores. For exemplary purposes, the block diagram of FIG. 3 will be described with reference to cluster 102a shown in FIG. 1 having the four processing cores 103a-103d shown in FIG. 1. Each processing core 103a-103d has a core power state machine (PSM) 301a-301d associated with it that manages the power modes for that particular core and entry into/exit out of LPMs, both for clock gating and power gating LPMs. The core PSMs 301a-301d associated with the cores 103a-103d, respectively, are contained in the globals unit 108 of the cluster 102a. A cluster PSM 302, which is also part of the globals unit 108, manages the power modes for the cluster 102a. The cluster PSM 302 communicates with independent firmware 303 of the cluster running on the PDP 107 of the cluster 102a, which can be a microcontroller, for example. The PDP 107 communicates with the CPUCP 101b of the SoC.

As indicated above, some aspects of power management of the cores 103a-103d and of the clusters 102a-102c are managed through the system software 122 executed by the CPU 101a and controlled by the kernel of the HLOS 121, whereas other aspects of power management of the cores 103a-103d and of the clusters 102a-102c are managed by the core and cluster PSMs 301a-301d and 302 in combination with firmware running on the PDP 107 independently of the CPU 101a and HLOS 121.

Block 304 represents the condition in which at least one processing core 103a-103d is in the active state (i.e., running). The respective core PSM 301a, 301b, 301c or 301d manages the power state of the core when it is in the active state and when it enters and exits LPM states. When at least one of the cores 103a-103d is in the active state, the cluster 102a is also in the active state, as indicated by block 305. In the active state, the cluster 102a is not in a low power mode.

Block 306 represents the condition in which all of the processing cores 103a-103d are in a LPM state and at least one of the LPM states is the clock gating state. When this condition is detected, the cluster clock gating state is autonomously triggered for the cluster 102a, as indicated by block 307. The term “autonomously triggered” means that the cluster clock gating state is triggered independently of the CPU 101a and HLOS 121. For example, the cores 103a-103d send notifications to the firmware 303 running on the PDP 107 that informs it of the states that the cores are in such that when the firmware detects the condition represented by block 306, the firmware 303 triggers the cluster clock gating represented by block 307. As indicated above, with the existing power management solution, the clock speed in the cluster clock gating state represented by block 307 is the same as the clock speed in the cluster ungated state, which results in significant power leakage even when the cluster is the clock gating state.

Block 308 represents the condition in which all of the processing cores 103a-103d are in a collapsed state and software aggregation is being performed only at the core level and not at the cluster level. When a core is in the “collapsed” state, some form of power gating is being performed: either (1) the supply rail sourcing the core is turned off, or (2) the GDHS switch connecting the core to the supply rail has been placed in the “open” state to disconnect the supply rail from the core. Software aggregation at the core level means that the CPU 101a is running system software 122 that predicts, based on the dynamic system load or state, whether one or more of the cores is not currently needed or will not be needed in the near future (e.g., in a few milliseconds) and that the core can therefore be placed in the collapsed state.

When the condition of block 308 is detected, the cluster clock gating state represented by block 307 is autonomously triggered. As indicated above, with the current power management solution, the clock speed in the clock gating state is the same as the clock speed in the clock ungated state, resulting in significant power leakage even when the cluster is in the clock gating state.

Block 309 represents the condition in which all of the processing cores 103a-103d of the cluster 102a are in a collapsed state and software aggregation is being performed at the cluster level. Software aggregation at the cluster level means that the CPU 101a is running software that predicts, based on the dynamic system load or state of each cluster, whether one or more of the clusters is not currently needed or will not be needed in the near future (e.g., in a few milliseconds) and that the cluster can therefore be placed in the collapsed state. For example, if the SoC comprises two clusters, each having four cores, the CPU 101a may predict, based on the dynamic system load or state of each cluster, that one of the clusters is not needed for a few milliseconds and therefore places the cluster in the collapsed state (GHDS switched or supply rail turned off).

When the condition represented by block 309 is detected, the cluster 102a is placed in the collapsed state, as indicated by block 311. When the cluster 102a is in the collapsed state (GHDS or supply rail turned off), the cluster PSM 302 performs power management specific to the cluster 102a and interacts with the firmware 303 running on the cluster PDP 107 (e.g., a microcontroller or other type of processor). It should be noted that, with the existing power management solution represented by FIG. 3, when the cluster 102a is in the clock gating state represented by block 307, the cluster PSM 302 is not triggered. With the existing power management solution represented by FIG. 3, the cluster PSM 302 is only triggered when the condition represented by block 309 is detected, i.e., when the cluster 102a is in the collapsed state.

In accordance with inventive principles and concepts of the present disclosure, it has been determined that a significant reduction in power leakage can be realized by reducing the clock speed when a cluster is in the cluster clock gating mode represented by block 307. The following describes representative embodiments for reducing the clock speed, or for reducing both the clock speed and the supply voltage, when a cluster is in clock gating mode.

FIG. 4 is a block diagram of the power management system 400 of an SoC in accordance with a representative embodiment. In accordance with this representative embodiment, the system 400 includes a dynamic voltage and frequency scaling (DVFS) state machine 420 that scales down the clock frequency of the cluster, or scales down both the clock frequency and the supply voltage of the cluster, when the cluster is in clock gating mode. Blocks 401a-401d and 404-409 of FIG. 4 can represent the same states or elements represented by blocks 301a- 301d and 304-309 of FIG. 3, respectively. However, the configurations and operations performed by blocks 402 and 403 of FIG. 4 are modifications of the configurations and operations performed by blocks 302 and 303 of FIG. 3, respectively, as will now be described with reference to FIG. 4.

In accordance with this representative embodiment, when the conditions of blocks 406 or 408 are met, the core PSMs 401a-401d send an aggregated notification to the cluster PSM 402 that informs it that all of the cores 103a-103d of cluster 102a are in idle, low power, mode. The cluster PSM 402 also receives a notification represented by the arrow from block 407 to block 402 indicating that the cluster is in the clock gating state. The notification represented by the arrow output from block 407 indicating that at least one of the cores 103a-103d is in the clock gating state, which means that the cluster 102a is in the clock gating state, can be triggered by logic within the core PSMs 401a-401d or by other logic of the cluster 102a. The term “aggregated notification,” as that term is used herein, means that a notification is sent from each of the core PSMs 401a-401d such that the cluster PSM 402 receives all of the notifications.

When the cluster PSM 402 receives this aggregated notification and the indication represented by block 407 that the cluster 102a is in the clock gating state, it preferably generates an interrupt signal that is received by the independent firmware 403 running on the PDP 107 (cluster microcontroller or other processor). The PDP 107 running the independent firmware 403 is configurable to control, and if needed, to make modifications to the operations it performs when the interrupt signal is received. When the independent firmware 403 receives the interrupt signal, it is aware of the clock frequency and supply voltage at which the cluster 102a is currently operating. The firmware 403 preferably contains a mapping of sets of clock frequency and supply voltage to respective power (P) states. Based on a first P state that the cluster 102a is in when the interrupt signal is received, the firmware 403 maps the first P state to a second P state associated with a scaled down set of clock frequency and supply voltage and outputs the second P state value to the DVFS state machine 420.

The DVFS state machine 420 receives the second P state from the firmware 403 and maps it to a scaled down clock frequency and supply voltage set, which it sends to hardware of the cluster that controls the supply voltage and clock frequency settings. It should be noted that a total change in the P state is not required, as the firmware 403 can cause the DVFS state machine 420 to make any configurational change, e.g., a clock pulse width reduction.

Preferably the DVFS state machine 420 scales down the clock frequency and supply voltage that were being used at the time the cluster PSM 402 entered the clock gating state to a reduced clock frequency and a reduced supply voltage, but it is also possible that the DVFS state machine 420 scales down the clock frequency without scaling down the supply voltage.

One of the benefits of reducing the clock speed during cluster clock gating in accordance with the present disclosure is that power consumption is being reduced without introducing the blocking delays associated with power gating. When power gating is performed, during the time required to enter and exit the power gating state, the cores are not running and therefore are not executing instructions. As indicated above, the timeline for entry and exit from LPM states is longer for power gating than it is for clock gating. If the cluster is in cluster clock gating mode when the cluster load increases, one or more of the cores can quickly exit the LPM state, enter the active state and begin fetching and executing instructions at the reduced clock frequency even before the clock frequency and supply voltage are scaled back up to the clock frequency and supply voltage that were being used just prior to entering cluster clock gating mode. In this way, the system and method of the present disclosure provide a cluster clock gating parallel path to cluster power gating for reducing clock speed to achieve power savings without introducing the processing delays associated with cluster power gating.

Another benefit of the system and method of the present disclosure is that instructions can be fetched and executed by the cores during the process of scaling up and scaling down the clock frequency and supply voltage. Instructions can be fetched and executed by the cores in parallel with the scaling up/down of the clock frequency and supply voltage. When the cluster PSM 402 initially enters the cluster clock gating state, it stores the current clock frequency and supply voltage settings in memory. When the cluster PSM 402 exits the cluster clock gating state, it preferably retrieves the previous clock frequency and supply voltage settings from memory and restores the previous state such that the cluster resumes using the previous clock frequency and supply voltage. During these transitions, the active core(s) 103a-103d can perform operations at the scaled up and scaled down clock speeds.

Another benefit of the system and method of the present disclosure is that the scaling up/down feature of the present disclosure preferably can be selectively enabled and disabled at runtime. Therefore, at times in which performing the scaling operations is undesired or unnecessary, it can be disabled.

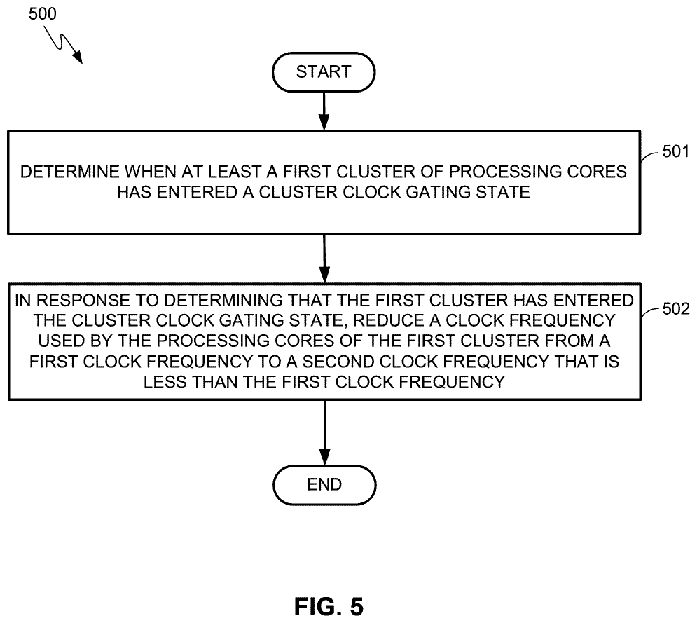

FIG. 5 is a flow diagram that represents the method of the present disclosure in accordance with a representative embodiment for reducing power leakage in an SoC. Block 501 represents the step of determining when at least a first cluster of processing cores has entered a cluster clock gating state. Bock 502 represents the step of, in response to determining that the first cluster has entered the cluster clock gating state, reducing a clock frequency used by the processing cores of the first cluster from a first clock frequency to a second clock frequency that is less than the first clock frequency.

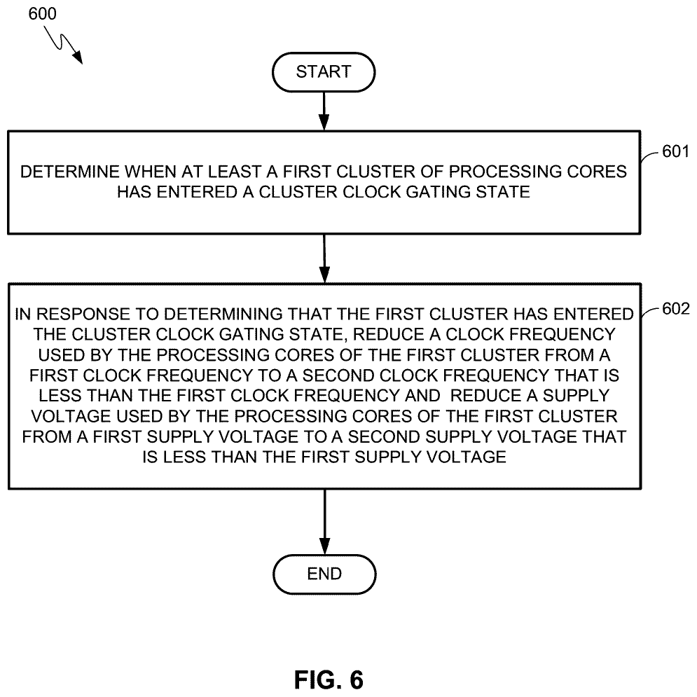

FIG. 6 is a flow diagram that represents the method of the present disclosure in accordance with another representative embodiment for reducing power leakage in an SoC. Block 601 represents the step of determining when at least a first cluster of processing cores has entered a cluster clock gating state. Bock 602 represents the step of, in response to determining that the first cluster has entered the cluster clock gating state, reducing a clock frequency used by the processing cores of the first cluster from a first clock frequency to a second clock frequency that is less than the first clock frequency and reducing a supply voltage used by the processing cores from a first supply voltage to a second supply voltage that is less than the first supply voltage.

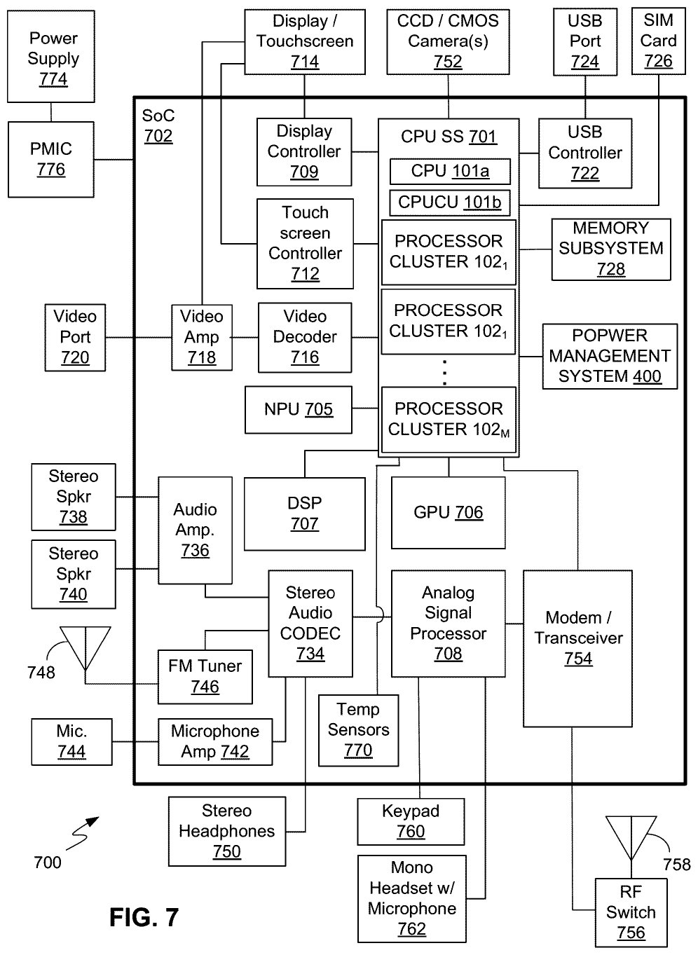

FIG. 7 illustrates an example of a PCD 700, such as a mobile phone or a smartphone, for example, in which exemplary embodiments of systems, methods, computer-readable media, and other examples of the inventive principles and concepts of the present disclosure may be implemented. For purposes of clarity, some interconnects, signals, etc., are not shown in FIG. 7. The PCD 700 comprises an SoC 702 that comprises a CPU subsystem (CPU SS) 701 comprising the CPU 101a, the CPUCP 101b and M clusters 102₁-102_{M} that can have the configuration shown in FIG. 1, each having multiple processing cores, where M is a positive integer. The SoC 702 also comprises the power management system 400 shown in FIG. 4 that performs the methods described above with reference to FIGS. 4, 5 and 6.

The SoC 702 may include a variety of other subsystems, such as, for example, a memory subsystem 728, an NPU 705, a GPU 706, a DSP 707, an analog signal processor 708, a modem/transceiver 754, etc. A display controller 709 and a touch-screen controller 712 may be coupled to the CPU SS 701. A touchscreen display 714 external to the SoC 702 may be coupled to the display controller 709 and the touch-screen controller 712. The PCD 700 may further include a video decoder 716 coupled to the CPU SS 701. A video amplifier 718 may be coupled to the video decoder 716 and to the touchscreen display 714. A video port 720 may be coupled to the video amplifier 718. A universal serial bus (“USB”) controller 722 may also be coupled to CPU SS 701, and a USB port 724 may be coupled to the USB controller 722. A subscriber identity module (“SIM”) card 726 may also be coupled to the CPU SS 701.

The memory subsystem 728 may be coupled to the CPU SS 701. The memory subsystem 728 may include both volatile and non-volatile memories. Examples of volatile memories include static random access memory (“SRAM”) and dynamic random access memory (“DRAM”). The one or more memories may include local cache memory and a system-level cache memory (e.g., level 3 (L3) cache memory). The CPU SS 701 may also include cache memory, e.g., L1 and L2 cache memories.

A stereo audio CODEC 734 may be coupled to the analog signal processor 708. Further, an audio amplifier 736 may be coupled to the stereo audio CODEC 734. First and second stereo speakers 738 and 740, respectively, may be coupled to the audio amplifier 736. In addition, a microphone amplifier 742 may be coupled to the stereo audio CODEC 734, and a microphone 744 may be coupled to the microphone amplifier 742. A frequency modulation (“FM”) radio tuner 746 may be coupled to the stereo audio CODEC 734. An FM antenna 748 may be coupled to the FM radio tuner 746. Further, stereo headphones 750 may be coupled to the stereo audio CODEC 734. Other devices that may be coupled to the CPU SS 701 include one or more digital (e.g., CCD or CMOS) cameras 752.

The modem/transceiver 754 may be coupled to the analog signal processor 708 and to the CPU SS 7701. An RF switch 756 may be coupled to the modem/transceiver 754 and to an RF antenna 758. A keypad 760 and a mono headset with a microphone 762 may be coupled to the analog signal processor 708. The SoC 702 may have one or more internal or on-chip thermal sensors 770. A power supply 774 and a power management IC (PMIC) 776 may supply power to the SoC 702.

It should be noted that while the representative embodiments have been described with reference to the inventive principles and concepts being implemented in a combination of hardware (state machines) and firmware executed by a processor (e.g., a microcontroller), the inventive principles and concepts can also be implemented in software being executed by a processor or in a combination of software and hardware and/or firmware.

Firmware or software may be stored in any of the above-described memories, or may be stored in a local memory directly accessible by the processor hardware on which the software or firmware executes. The methods described above with reference to FIGS. 4-6 may be executed solely in hardware or in a combination of hardware and software and/or firmware. Any software and/or firmware can be stored in any suitable memory device, either local to the subsystem or external to it. Any such memory or other non-transitory storage medium having firmware or software stored therein in computer-readable form may be an example of a non-transitory “computer-readable medium,” as the term is understood in the patent lexicon.

Implementation examples are described in the following numbered clauses:
1. A method for reducing power leakage in a system-on-a-chip (SoC), the method comprising:
determining when at least a first cluster of processing cores has entered a cluster clock gating state; and
in response to determining that the first cluster has entered the cluster clock gating state, reducing a clock frequency used by the processing cores of the first cluster from a first clock frequency to a second clock frequency, the second clock frequency being less than the first clock frequency.
2. The method of clause 1, further comprising:
determining when the first cluster of processing cores has exited the cluster clock gating state; and
in response to determining that the first cluster has exited the cluster clock gating state, increasing the clock frequency used by the processing cores of the first cluster from the second clock frequency to the first clock frequency.
3. The method of any of clauses 1-2, further comprising:
in response to determining that the first cluster has entered the cluster clock gating state, reducing a supply voltage used by the processing cores of the first cluster from a first supply voltage to a second supply voltage, the second supply voltage being less than the first supply voltage.
4. The method of any of clauses 1-3, further comprising:
in response to determining that the first cluster has exited the cluster clock gating state, increasing the supply voltage used by the processing cores of the first cluster from the second supply voltage to the first supply voltage.
5. The method of any of clauses 1-4, wherein the first cluster comprises a plurality of processing cores and a plurality of respective core state machines, each core state machine performing power management for the respective processing core, and wherein the first cluster further comprises:
a cluster state machine that performs power management for the first cluster;
a firmware processor running firmware; and
a dynamic voltage and frequency scaling (DVFS) state machine, and wherein the core power state machines send an aggregated notification to the cluster power state machine to notify the cluster power state machine when the processing cores are all in an idle, low power, state, and wherein the step of determining when the first cluster has entered the cluster clock gating state includes detecting that the aggregated notification has been received by the cluster power state machine.
6. The method of clause 5, wherein the step of responding to the determination that the first cluster has entered the cluster clock gating state comprises:
with the cluster power state machine, sending an interrupt signal from the cluster power state machine to the firmware processor;
in the firmware processor, receiving the interrupt signal, entering a power (P) state associated with the second clock frequency and the second supply voltage and outputting a signal to the DVFS state machine; and
in the DVFS state machine, receiving the signal output from the firmware processor and outputting a signal that causes circuitry of the first cluster to select the second clock frequency and second supply voltage for use by the processing cores.
7. The method of any of clauses 1-6, wherein the step of determining when the first cluster of processing cores has entered the cluster clock gating state comprises:
determining whether all of the processing cores are in an idle, low power, state and whether at least one of the processing cores is in a core clock gating state, wherein in response to determining that all of the processing cores are in an idle, low power, state and that at least one of the processing cores is in a core clock gating state, a determination is made that the first cluster has entered the cluster clock gating state.
8. The method of any of clauses 1-7, wherein the step of determining when the first cluster of processing cores has entered the cluster clock gating state further comprises:
determining whether all of the processing cores are in a collapsed, low power, state and whether software aggregation is being performed at a processing core level and not at a cluster level, wherein in response to determining that all of the processing cores are in a collapsed, low power, state and that software aggregation is being performed at a processing core level and not at a cluster level, a determination is made that the first cluster has entered the cluster clock gating state.
9. A power management system for reducing power leakage in a system-on-a-chip (SoC), the system comprising:
processing logic configured to:
determine when at least a first cluster of processing cores has entered a cluster clock gating state; and
in response to determining that the first cluster has entered the cluster clock gating state, reduce a clock frequency used by the processing cores of the first cluster from a first clock frequency to a second clock frequency, the second clock frequency being less than the first clock frequency.
10. The power management system of clause 9, wherein the processing logic is further configured to:
determine when the first cluster of processing cores has exited the cluster clock gating state; and
in response to determining that the first cluster has exited the cluster clock gating state, increase the clock frequency used by the processing cores of the first cluster from the second clock frequency to the first clock frequency.
11. The power management system of any of clauses 9-10, wherein the processing logic is further configured to:
in response to determining that the first cluster has entered the cluster clock gating state, reduce a supply voltage used by the processing cores of the first cluster from a first supply voltage to a second supply voltage, the second supply voltage being less than the first supply voltage.
12. The power management system of any of clauses 9-11, wherein the processing logic is further configured to:
in response to determining that the first cluster has exited the cluster clock gating state, increase the supply voltage used by the processing cores of the first cluster from the second supply voltage to the first supply voltage.
13. The power management system of any of clauses 9-12, wherein the processing logic comprises:
a plurality of core power state machines, each of the core power state machines being configured to perform power management for a respective processing core of said plurality of processing cores and to output a respective notification signal indicating when the respective processing core is in an idle, low power, state;
a cluster state machine configured to perform power management for the first cluster, and wherein the cluster power state machine is configured to determine when the first cluster has entered the cluster clock gating state by detecting when an aggregate of the notification signals has been received by the cluster power state machine indicating that all of the processing cores are in the idle, low power, state, the cluster power state machine being configured to output an interrupt signal when the aggregate of the notification signals is received by the cluster power state machine;
a firmware processor configured to run firmware that performs power management operations in response to receiving the interrupt signal output by the cluster power state machine; and
a dynamic voltage and frequency scaling (DVFS) state machine configured to receive an output signal from the firmware processor in response to the firmware processor receiving the interrupt signal, the DVFS state machine being configured to, based at least in part on the output signal received from the firmware processor, generate an output signal that causes circuitry of the cluster to select the second clock frequency and second supply voltage for use by the processing cores.
14. The power management system of any of clauses 9-13, wherein the processing logic is configured to determine when the first cluster of processing cores has entered the cluster clock gating state by:
determining whether all of the processing cores are in an idle, low power, state and whether at least one of the processing cores is in a core clock gating state, wherein in response to determining that all of the processing cores are in an idle, low power, state and that at least one of the processing cores is in a core clock gating state, a determination is made by the processing logic that the first cluster has entered the cluster clock gating state.
15. The power management system of any of clauses 9-14, wherein the processing logic is further configured to determine when the first cluster of processing cores has entered the cluster clock gating state by:
determining whether all of the processing cores are in a collapsed, low power, state and whether software aggregation is being performed at a processing core level and not at a cluster level, wherein in response to determining that all of the processing cores are in a collapsed, low power, state and that software aggregation is being performed at a processing core level and not at a cluster level, a determination is made by the processing logic that the first cluster has entered the cluster clock gating state.
16. A computer program for controlling a power management system in a system-on-a-chip (SoC) to perform power management, the computer program being embodied on a non-transitory computer readable medium and comprising computer instructions for execution by one or more processors, the computer instructions comprising:
a first set of computer instructions for determining when at least a first cluster of processing cores has entered a cluster clock gating state; and a second set of computer instructions for, in response to determining that the first cluster has entered the cluster clock gating state, reducing a clock frequency used by the processing cores of the first cluster from a first clock frequency to a second clock frequency, the second clock frequency being less than the first clock frequency.
17. The computer program of clause 16, further comprising:
a third set of computer instructions for determining when the first cluster of processing cores has exited the cluster clock gating state; and a fourth set of computer instructions for, in response to determining that the first cluster has exited the cluster clock gating state, increasing the clock frequency used by the processing cores of the first cluster from the second clock frequency to the first clock frequency.
18. The computer program of clause 16, further comprising:
a third set of computer instructions for, in response to determining that the first cluster has entered the cluster clock gating state, reducing a supply voltage used by the processing cores of the first cluster from a first supply voltage to a second supply voltage, the second supply voltage being less than the first supply voltage.
19. The computer program of clause 18, further comprising:
a fourth set of computer instructions for, in response to determining that the first cluster has exited the cluster clock gating state, increasing the supply voltage used by the processing cores of the first cluster from the second supply voltage to the first supply voltage.
20. The computer program of any of clauses 16-19, wherein the first set of computer instructions determines that the first cluster of processing cores has entered the cluster clock gating state by determining (1) that all of the processing cores are in an idle, low power, state and at least one of the processing cores is in a core clock gating state or (2) that all of the processing cores are in a collapsed, low power, state and that software aggregation is being performed at a processing core level and not at a cluster level.

Alternative embodiments will become apparent to one of ordinary skill in the art to which the invention pertains in view of the present disclosure. Therefore, although selected aspects have been illustrated and described in detail, it will be understood that various substitutions and alterations may be made therein.

What is claimed is:

1. A method for reducing power leakage in a system-on-a-chip (SoC), the method comprising:
determining when at least a first cluster of processing cores has entered a cluster clock gating state; and
in response to determining that the first cluster has entered the cluster clock gating state, reducing a clock frequency used by the processing cores of the first cluster from a first clock frequency to a second clock frequency, the second clock frequency being less than the first clock frequency.

2. The method of claim 1, further comprising:
determining when the first cluster of processing cores has exited the cluster clock gating state; and
in response to determining that the first cluster has exited the cluster clock gating state, increasing the clock frequency used by the processing cores of the first cluster from the second clock frequency to the first clock frequency.

3. The method of claim 1, further comprising:
in response to determining that the first cluster has entered the cluster clock gating state, reducing a supply voltage used by the processing cores of the first cluster from a first supply voltage to a second supply voltage, the second supply voltage being less than the first supply voltage.

4. The method of claim 3, further comprising:
in response to determining that the first cluster has exited the cluster clock gating state, increasing the supply voltage used by the processing cores of the first cluster from the second supply voltage to the first supply voltage.

5. The method of claim 3, wherein the first cluster comprises a plurality of processing cores and a plurality of respective core state machines, each core state machine performing power management for the respective processing core, and wherein the first cluster further comprises:
a cluster state machine that performs power management for the first cluster;
a firmware processor running firmware; and
a dynamic voltage and frequency scaling (DVFS) state machine, and wherein the core power state machines send an aggregated notification to the cluster power state machine to notify the cluster power state machine when the processing cores are all in an idle, low power, state, and wherein the step of determining when the first cluster has entered the cluster clock gating state includes detecting that the aggregated notification has been received by the cluster power state machine.

6. The method of claim 5, wherein the step of responding to the determination that the first cluster has entered the cluster clock gating state comprises:
with the cluster power state machine, sending an interrupt signal from the cluster power state machine to the firmware processor;
in the firmware processor, receiving the interrupt signal, entering a power (P) state associated with the second clock frequency and the second supply voltage and outputting a signal to the DVFS state machine; and
in the DVFS state machine, receiving the signal output from the firmware processor and outputting a signal that causes circuitry of the first cluster to select the second clock frequency and second supply voltage for use by the processing cores.

7. The method of claim 1, wherein the step of determining when the first cluster of processing cores has entered the cluster clock gating state comprises:
determining whether all of the processing cores are in an idle, low power, state and whether at least one of the processing cores is in a core clock gating state, wherein in response to determining that all of the processing cores are in an idle, low power, state and that at least one of the processing cores is in a core clock gating state, a determination is made that the first cluster has entered the cluster clock gating state.

8. The method of claim 1, wherein the step of determining when the first cluster of processing cores has entered the cluster clock gating state comprises:
determining whether all of the processing cores are in a collapsed, low power, state and whether software aggregation is being performed at a processing core level and not at a cluster level, wherein in response to determining that all of the processing cores are in a collapsed, low power, state and that software aggregation is being performed at a processing core level and not at a cluster level, a determination is made that the first cluster has entered the cluster clock gating state.

9. A power management system for reducing power leakage in a system-on-a-chip (SoC), the system comprising:
processing logic configured to:
determine when at least a first cluster of processing cores has entered a cluster clock gating state; and
in response to determining that the first cluster has entered the cluster clock gating state, reduce a clock frequency used by the processing cores of the first cluster from a first clock frequency to a second clock frequency, the second clock frequency being less than the first clock frequency.

10. The power management system of claim 9, wherein the processing logic is further configured to:
determine when the first cluster of processing cores has exited the cluster clock gating state; and
in response to determining that the first cluster has exited the cluster clock gating state, increase the clock frequency used by the processing cores of the first cluster from the second clock frequency to the first clock frequency.

11. The power management system of claim 9, wherein the processing logic is further configured to:
in response to determining that the first cluster has entered the cluster clock gating state, reduce a supply voltage used by the processing cores of the first cluster from a first supply voltage to a second supply voltage, the second supply voltage being less than the first supply voltage.

12. The power management system of claim 11, wherein the processing logic is further configured to:
in response to determining that the first cluster has exited the cluster clock gating state, increase the supply voltage used by the processing cores of the first cluster from the second supply voltage to the first supply voltage.

13. The power management system of claim 11, wherein the processing logic comprises:
a plurality of core power state machines, each of the core power state machines being configured to perform power management for a respective processing core of said plurality of processing cores and to output a respective notification signal indicating when the respective processing core is in an idle, low power, state;
a cluster state machine configured to perform power management for the first cluster, and wherein the cluster power state machine is configured to determine when the first cluster has entered the cluster clock gating state by detecting when an aggregate of the notification signals has been received by the cluster power state machine indicating that all of the processing cores are in the idle, low power, state, the cluster power state machine being configured to output an interrupt signal when the aggregate of the notification signals is received by the cluster power state machine;
a firmware processor configured to run firmware that performs power management operations in response to receiving the interrupt signal output by the cluster power state machine; and
a dynamic voltage and frequency scaling (DVFS) state machine configured to receive an output signal from the firmware processor in response to the firmware processor receiving the interrupt signal, the DVFS state machine being configured to, based at least in part on the output signal received from the firmware processor, generate an output signal that causes circuitry of the cluster to select the second clock frequency and second supply voltage for use by the processing cores.

14. The power management system of claim 9, wherein the processing logic is configured to determine when the first cluster of processing cores has entered the cluster clock gating state by:
determining whether all of the processing cores are in an idle, low power, state and whether at least one of the processing cores is in a core clock gating state, wherein in response to determining that all of the processing cores are in an idle, low power, state and that at least one of the processing cores is in a core clock gating state, a determination is made by the processing logic that the first cluster has entered the cluster clock gating state.

15. The power management system claim 9, wherein the processing logic is configured to determine when the first cluster of processing cores has entered the cluster clock gating state by:
determining whether all of the processing cores are in a collapsed, low power, state and whether software aggregation is being performed at a processing core level and not at a cluster level, wherein in response to determining that all of the processing cores are in a collapsed, low power, state and that software aggregation is being performed at a processing core level and not at a cluster level, a determination is made by the processing logic that the first cluster has entered the cluster clock gating state.

16. A computer program for controlling a power management system in a system-on-a-chip (SoC) to perform power management, the computer program being embodied on a non-transitory computer readable medium and comprising computer instructions for execution by one or more processors, the computer instructions comprising:
a first set of computer instructions for determining when at least a first cluster of processing cores has entered a cluster clock gating state; and
a second set of computer instructions for, in response to determining that the first cluster has entered the cluster clock gating state, reducing a clock frequency used by the processing cores of the first cluster from a first clock frequency to a second clock frequency, the second clock frequency being less than the first clock frequency.

17. The computer program of claim 16, further comprising:
a third set of computer instructions for determining when the first cluster of processing cores has exited the cluster clock gating state; and
a fourth set of computer instructions for, in response to determining that the first cluster has exited the cluster clock gating state, increasing the clock frequency used by the processing cores of the first cluster from the second clock frequency to the first clock frequency.

18. The computer program of claim 16, further comprising:
a third set of computer instructions for, in response to determining that the first cluster has entered the cluster clock gating state, reducing a supply voltage used by the processing cores of the first cluster from a first supply voltage to a second supply voltage, the second supply voltage being less than the first supply voltage.

19. The computer program of claim 18, further comprising:
a fourth set of computer instructions for, in response to determining that the first cluster has exited the cluster clock gating state, increasing the supply voltage used by the processing cores of the first cluster from the second supply voltage to the first supply voltage.

20. The computer program of claim 16, wherein the first set of computer instructions determines that the first cluster of processing cores has entered the cluster clock gating state by determining (1) that all of the processing cores are in an idle, low power, state and at least one of the processing cores is in a core clock gating state or (2) that all of the processing cores are in a collapsed, low power, state and that software aggregation is being performed at a processing core level and not at a cluster level.
